(19) United States
(12) Patent Application Publication
(10) Pub. No.: US 2022/0284076 A1
(43) Pub. Date: Sep. 8, 2022

(54) REAL-TIME OUTLIER DETECTION METHOD AND APPARATUS IN MULTIDIMENSIONAL DATA STREAM

(71) Applicant: KOREA ADVANCED INSTITUTE OF SCIENCE AND TECHNOLOGY, Daejeon (KR)

(72) Inventors: Jae-Gil LEE, Daejeon (KR); Susik YOON, Daejeon (KR); Byung Suk LEE, Burlington, VT (US)

(21) Appl. No.: 17/354,219

(22) Filed: Jun. 22, 2021

(30) Foreign Application Priority Data
Mar. 4, 2021 (KR) 10-2021-0029081

(51) Int. Cl. G06F 17/17; G06F 16/22

(52) U.S. Cl. CPC G06F 17/175; G06F 16/2264

(57) ABSTRACT

An outlier detection device sets a weight for a kernel center of a grid cell based on a distribution of the data disposed on the grid cell region, calculates a cumulative change of a weight for each corresponding kernel center, sets a stationary region in the grid cell region based on the cumulative change, maintains a density of a kernel center of the stationary region as a previous density, calculates a density of a kernel center excluding the stationary region to update the calculated density, estimates a density of multidimensional data at the current time, and detects an arbitrary number of outliers based on a relative difference between the density of the multidimensional data and a density of a kernel center nearest to the multidimensional data.

### CROSS-REFERENCE TO RELATED APPLICATION

This application claims priority to and the benefit of Korean Patent Application No. 10-2021-0029081 filed in the Korean Intellectual Property Office on Mar. 4, 2021, the entire contents of which are incorporated herein by reference.

### BACKGROUND

### (a) Field

The present disclosure relates to a real-time outlier detection technology in a multidimensional data stream.

### (b) Description of the Related Art

A multidimensional data stream refers to data that is continuously generated in time series in a data space consisting of at least one dimension. Partial characteristics of the data are defined in each dimension, and comprehensive characteristics of the data are defined by assembling characteristics in all dimensions. Since the multidimensional data stream is generated continuously and unbounded, real-time detection of outliers from the data stream is important.

The outliers refer to data that shows a large difference in the similarity with other data in a data set consisting of a plurality of data.

The outliers exist scarcely in a multidimensional data distribution estimated from a given data set. The outliers are anomalies, potential risk factors, noise, and the like in real applications.

Since the multidimensional data stream changes in real-time, it is a common practice in continuous outlier detection to use a sliding window to consider only the most recent data points. As a window slides, new data points are added to the window, and old data points expire from the window. Then, any data points significantly different from others in that window are labeled as outliers.

However, previous methods update the data density on the recent data set while continuously updating the recent data stream distribution. Then outliers are detected by comparing relative densities. Since the data density in every window slide is repeatedly updated, the density estimation requires a large amount of calculation. Therefore, it has a limitation in performing rapid outlier detection.

### SUMMARY

An embodiment of the present disclosure provides a real-time outlier detection method and device that approximate multidimensional data on the basis of a kernel center of a grid cell, set a grid cell-based stationary region based on a cumulative change of the kernel center for the real-time multidimensional data, and skip updating a density of the kernel center for the stationary region.

An embodiment of the present disclosure provides a real-time outlier detection method and device that detect an outlier based on a relative difference between a density of multidimensional data and a density of a kernel center nearest to each of the multidimensional data.

A real-time outlier detection method according to an embodiment comprises disposing multidimensional data input in real time on a grid cell region, setting a weight for a kernel center of each grid cell based on a data distribution on the grid cell region, calculating a cumulative change of a weight for each corresponding kernel center by comparing a data distribution at a current time and a data distribution at a previous time, setting a stationary region in the grid cell region based on the cumulative change, maintaining a density of a kernel center of the stationary region as a previous density, calculating a density of a kernel center excluding the stationary region to update the calculated density, estimating a density of multidimensional data at the current time, and detecting an arbitrary number of outliers based on a relative difference between the density of the multidimensional data and a density of a kernel center nearest to the multidimensional data.

Setting the weight for the kernel center may comprise setting number of multidimensional data positioned in the grid cell as the weight of the kernel center for the grid cell.

Setting the stationary region may comprise classifying a grid cell whose cumulative change, representing a net change in the number of data, is less than or equal to a predetermined threshold as the stationary region and classifying a grid cell whose cumulative change is greater than the threshold as an update region.

Calculating the density of the kernel center excluding the stationary region may comprise calculating the density of the corresponding kernel center based on a kernel function and distances with the k (k is a natural number) nearest different kernel centers in the update region.

Detecting the arbitrary number of outliers may comprise estimating a density of each multidimensional data based on a kernel function and distances among the k (k is a natural number) nearest kernel centers at a position of each multidimensional data at the current time.

Detecting the arbitrary number of outliers may comprise estimating the relative difference as an outlier score, and detecting the arbitrary number of multidimensional data in the sequential order of the highest outlier score as the outliers or detecting multidimensional data whose outlier score is greater than or equal to a predetermined allowance threshold as the outliers.

Detecting the arbitrary number of outliers may comprise estimating an upper bound and a lower bound of a density of the multidimensional data for each grid cell based on the position of the multidimensional data in the grid cell, and calculating an upper bound and a lower bound of an outlier score based on the upper bound and the lower bound of the density of the multidimensional data.

Detecting the arbitrary number of outliers may comprise comparing an upper bound and a lower bound of an outlier score for each grid cell to select, as a candidate grid cell, at least one grid cell having a lower bound of the outlier score higher than an upper bound of the outlier score of some grid cells, and detecting the arbitrary number of the multidimensional data as the outliers from the multidimensional data positioned in the candidate grid cell.

A computing device according to an embodiment comprises a memory including instructions and at least one processor that executes the instructions to detect an outlier in a multidimensional data stream. The processor may dispose multidimensional data input in real time on a grid cell region and sets a weight for a kernel center of each grid cell based on a data distribution on the grid cell region, classify a stationary region and an update region according to a cumulative change of a weight predetermined for a kernel center of the corresponding grid cell, by comparing a data distribution at a current time and a data distribution at a previous time, calculate a density of a kernel center in the update region to update the calculated density, estimate a density for each of the multidimensional data, and detect, an arbitrary number of outliers based on a relative difference between a density of the multidimensional data and a density of the kernel center nearest to the corresponding multidimensional data.

The processor may set the number of the multidimensional data positioned in the grid cell as the weight of the kernel center, and calculates a cumulative change from a change in a weight distribution of the kernel center.

The processor may calculate a density of the kernel center or a density of the multidimensional data based on a kernel function and distances with the k nearest kernel centers at each position.

The processor may maintain a density of the kernel center of the stationary region as a previous density, calculate the density of the kernel center of the update region excluding the stationary region, update the calculated density of the kernel center, and store the density of the kernel center at the current time.

The processor may estimate an upper bound and a lower bound of the density of the multidimensional data for each grid cell based on a position of the multidimensional data in the grid cell, calculate an upper bound and a lower bound of the relative difference based on the upper bound and the lower bound of the density, and selects, as a candidate grid cell, a grid cell that has the lower bound of the relative difference greater than the upper bounds of other grid cells through comparing the upper bounds and the lower bounds of the grid cells.

The processor may select at least one candidate grid cell so that the number of multidimensional data positioned in the candidate grid cell is greater than the arbitrary number, and select the arbitrary number of the multidimensional data in the sequentially higher order of the relative difference as outliers among the multidimensional data positioned in the candidate grid cell.

According to an embodiment of the present disclosure, unnecessary density update is prevented by skipping update for the stationary region. Thus, the calculation amount can be minimized, thereby improving the speed of outlier detection.

According to an embodiment of the present disclosure, the improvement of detection speed is secured without degrading the outlier detection accuracy, by setting the stationary region through comparison of a predetermined threshold and a cumulative change calculated based on a weight change of the nearest kernel center of each multidimensional data.

### BRIEF DESCRIPTION OF THE DRAWINGS

FIG. 1A is an example diagram showing an existing outlier detection method and FIG. 1B is an outlier detection method according to an embodiment.

FIG. 2 is a configuration diagram showing an outlier detection device according to an embodiment.

FIG. 3A and FIG. 3B are example diagrams illustrating a process of selecting an update region through data distribution approximation according to an embodiment.

FIG. 4 is a flowchart showing an outlier detection method according to an embodiment.

FIG. 5A and FIG. 5B are example diagrams illustrating a process of local density estimation by a data distribution approximation according to an embodiment.

FIG. 6 is an example diagram illustrating a stationary region and an update region according to an embodiment.

FIG. 7A, FIG. 7B and FIG. 7C are example diagrams illustrating a process of detecting an outlier in a real-time multidimensional data stream according to an embodiment.

FIG. 8 is a result graph of a sensitivity experiment for a threshold of a cumulative change according to an embodiment.

FIG. 9A and FIG. 9B are result graphs showing performance evaluation of the present disclosure.

FIG. 10 is a hardware configuration diagram of a computing device according to an embodiment.

### DETAILED DESCRIPTION OF THE EMBODIMENTS

Hereinafter, embodiments of the present disclosure will be described in detail with reference to the attached drawings so that the person of ordinary skill in the art may easily implement the present disclosure. However, the present disclosure may be modified in various ways and is not limited to the embodiments described herein. In the drawings, elements irrelevant to the description of the present disclosure are omitted for simplicity of explanation, and like reference numerals designate like elements throughout the specification.

In the description, when a part is referred to “include” a certain element, it means that it may further include other elements rather than exclude other elements, unless specifically indicates otherwise.

The devices described in the present disclosure comprises a hardware including at least one processor, a memory, a communication device, and the like, and a computer program executed in combination with the hardware is stored in a predetermined space. The hardware may have configuration and performance available for implementing a method of the present disclosure. The computer program includes instructions implementing the operation method of the present disclosure described with reference to the accompanying drawings and performs the present disclosure in combination with hardware such as a processor and a memory.

In the description, the terms “transmit or provide” may be used to include not only direct transmission or provision but also indirect transmission or provision through another device or by using a bypass.

Throughout the specification, the singular forms “a”, “an”, and “the” are intended to include the plural forms as well, unless the explicit expression such as “one” or “singular” is used.

In the description, throughout the drawings, the same reference numeral refers to the same element, and “and/or” includes all combinations of each and at least one of the mentioned elements.

In the description, terms including ordinal numbers such as “first”, “second”, and the like may be used to describe various elements, but the elements are not limited by the terms. The terms are used only to discriminate one element from another. For example, a first element may be referred to as a second element, or similarly, the second element may be referred to as the first element, without departing from the scope of the present disclosure.

In the description, the operation order described in the flowchart may be changed, several operations may be merged, certain operations may be divided, and specific operations may not be performed.

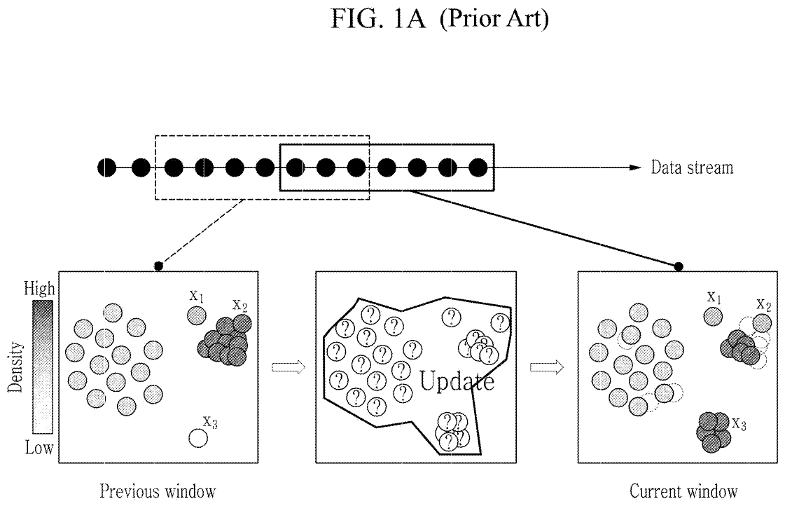

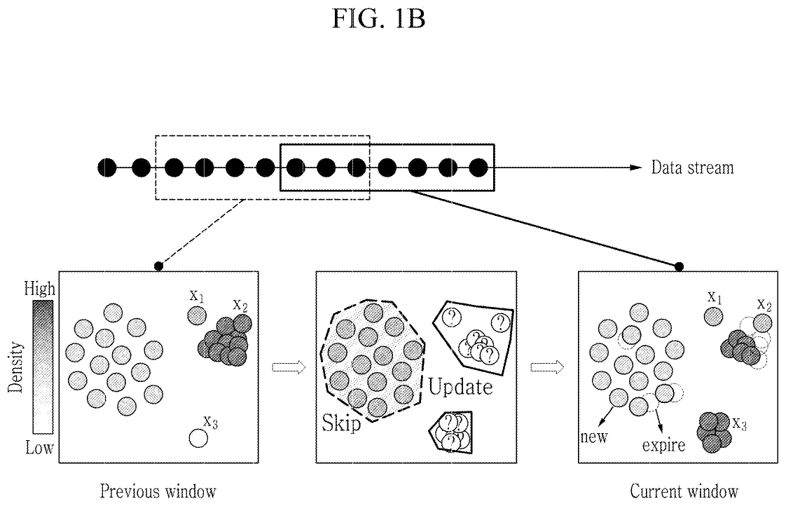

FIG. 1A is an example diagram showing an existing outlier detection method and FIG. 1B is an outlier detection method according to an embodiment.

FIG. 1A shows an outlier detection method according to an existing method performing global update, and FIG. 1B shows an outlier detection method, according to an embodiment, which skips update of a predetermined stationary region.

As shown in FIG. 1A, while the existing method based on global update performs overall update for the detected data. However, as shown in FIG. 1B, a proposed outlier detection method identifies local regions in which data distributions hardly change and then skips updating densities in a stationary region and only performs updating densities in a changed region.

Referring to FIG. 1A and FIG. 1B, there are two outliers, x1 and x3, in the previous window and, after the window slides, in the current window x2 becomes a new outlier, as it now has a lower density than its nearest neighbors, and x3 becomes an inlier, as it now has a similar density to its nearest neighbors' densities. Between the previous and current windows, the densities at data points change only in local regions on the right. However, referring to FIG. 1A, the existing method globally updates the densities at all data points. These excessive updates can be avoided with local updates as in the FIG. 1B, which allows for skipping the stationary regions on the left and estimate the densities only for the remaining local regions.

For example, a multidimensional data stream is acquired in a smart factory area and may be commonly generated by a digital twin based on sensors attached to the smart factory.

Since a multidimensional data stream is inherently unbounded, it is common to consider only the latest data point by using a sliding window in continuous outlier detection. The continuous sliding window may be set to overlap certain values. For example, some data detected in the previous window may expire in the current window, and some new data may be added. Then, in the next sliding window, all of the remaining data included in the first sliding window may expire, and new data may be added.

Since a density change is insignificant over most regions of the data space within a short time span, the present disclosure provides an outlier detection method that checks a data density change, classifies a stationary region with less density change and a changed region with a significant density change, updates the densities of the changed region, and detects outliers based thereon.

With data points typically skewed to local regions in the data space, outliers are likely to be identifiable only in the local region that they belong to, called local outliers. A density-based approach is able to find such local outliers effectively by labeling a data point as an outlier if it has a relatively lower density than its neighbors, where the density at a data point is determined by the data distribution in its local region.

Thus, the densities at many data points tend to be stationary in a windowed stream processing. In each sliding window, the densities are completely stationary for 68% of data points and nearly stationary (within 1% change across window slides) for 87% of data points, when averaged over six benchmark data sets. Therefore, it is possible to save work in density-based outlier detection by stationarity region skipping method.

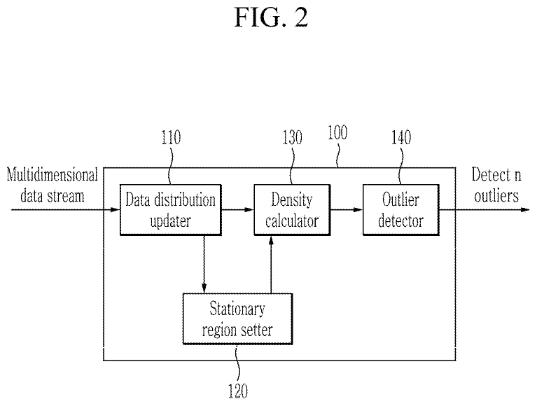

FIG. 2 is a configuration diagram showing an outlier detection device according to an embodiment.

As shown in FIG. 2, an outlier detection device 100 may include a data distribution updater 110 that updates a data distribution based on a multidimensional data stream, a stationary region setter 120 that sets a stationary region in the updated data distribution, a density calculator 130 that updates a density for a region of an updated data distribution excluding the stationary region, and an outlier detector 140 that detects an outlier in a regionally skewed distribution.

The data distribution updater 110, the stationary region setter 120, the density calculator 130, and the outlier detector 140 are named separately for explanation, but they can be operated by at least one processor. Here, the data distribution updater 110, the stationary region setter 120, the density calculator 130, and the outlier detector 140 may be implemented in a distributed manner with separate computing devices. In this case, they can communicate with each other via a communication interface.

At this time, the computing device capable of executing a software program written to perform the present disclosure is sufficient. And the computing device may be, for example, a server, a laptop computer, and the like.

The data distribution updater 110 disposes input multidimensional data on a grid cell region and approximates a distribution of the multidimensional data based on a kernel center of the grid cell.

The data distribution updater 110 disposes the multidimensional data in a grid cell region where grid cells of the same size are uniformly arranged and defines a kernel center being a center for each grid cell. The data distribution updater 110 may set a position of each kernel center and the number of multidimensional data positioned within the grid cell region as a weight of the kernel center.

In addition, the data distribution updater 110 may store a distribution of the multidimensional data disposed in the grid cell region on a separately equipped database.

Then, the data distribution updater 110 repeats the process of re-disposing the input multidimensional data on the grid cell region at a next time point and approximating the distribution of the multidimensional data based on the kernel center of the grid cell.

The stationary region setter 120 determines the stationary region by comparing a distribution of the multidimensional data approximated at a current time and a distribution of the multidimensional data approximated at an immediately previous time point.

The stationary region setter 120 may calculate a change in the nearest kernel center for each multidimensional data, and may determine, as the stationary region, a grid cell region having the cumulative change smaller than a threshold.

In other words, since a density of the multidimensional data is determined by a kernel center nearest to the multidimensional data, a density change can be estimated through a change in the weight of the nearest kernel center. Therefore, the stationary region setter 120 can calculate the cumulative change by using weight distributions of the kernel center at the immediately previous time point and at the current time point.

In addition, the stationary region setter 120 may set, as an update region, a grid cell region having the cumulative change greater than the threshold.

The density calculator 130 calculates a density of the kernel center for each grid cell region, and calculates the density of the multidimensional data.

The density calculator 130 calculates the density according to the distances of the k nearest kernel centers and a kernel function, and the method for calculating the densities of the kernel center and the multidimensional data may be applied in the same manner Here, k is a natural number and can be easily changed and set by an administrator later.

The density calculator 130 can update the density of a corresponding kernel center by calculating a cell density for each grid cell region excluding the stationary region.

In addition, the density calculator 130 may calculate an upper bound and a lower bound of the density of the data belonging to the grid cell for each grid cell.

The outlier detector 140 calculates an outlier score of each multidimensional data based on a relative difference between the density of the multidimensional data and the density of the nearest kernel center of the corresponding multidimensional data.

The outlier detector 140 can calculate an upper bound and a lower bound of each of the data density and the outlier score according to the position of the multidimensional data within the grid cell, and can rapidly detect a data with a high outlier score using the calculated upper bounds and the lower bounds.

Particularly, the outlier detector 140 can calculate an upper bound or a lower bound of the outlier score by using the upper bound and the lower bound of the density of the multidimensional data for each grid cell.

In addition, the outlier detector 140 may pre-exclude data that will not be detected as an outlier, based on the upper bound or the lower bound of the outlier score in a grid cell unit.

For example, when detecting three data with the highest outlier scores is required, if a grid cell including three or more data has a lower bound of the outlier score greater than an upper bound of other grid cell, the data included in the other grid cell may be excluded from consideration. Alternatively, if a lower bound of the outlier score of a grid cell including two data is greater than upper bounds of other grid cells, the corresponding grid cell is classified as a candidate grid cell. Further, among the remaining grid cells excluding the candidate cell, a grid cell whose lower bound of the outlier score is greater than the upper bounds of other grid cells may be classified as another candidate grid cell.

In other words, at least one grid cell may be selected as the candidate grid cell based on the number of multidimensional data to be detected.

After the upper bound and lower bound of the outlier score are determined for each grid cell as described above, the outlier detector 140 can select candidate grid cells that are assumed to have the Top-n outliers by comparing grid cell-by-grid cell, and can determine final Top-n outliers among the data included in the candidate grid cells.

Here, the term “Top-n” refers to an arbitrary number “n” (n is a natural number) predetermined in the sequential order of the highest outlier scores.

In this way, the outlier detector 140 may detect, as an outlier, an arbitrary predetermined number of multidimensional data in the sequential order of the highest outlier score. Alternatively, the outlier detector 140 may detect, as an outlier, the multidimensional data having an outlier score greater than or equal to an allowance threshold. Here, the allowance threshold, being a reference value set by an administrator, can be easily changed and set later.

The selection of the number of outliers to be detected can be easily changed and set later based on the applied conditions.

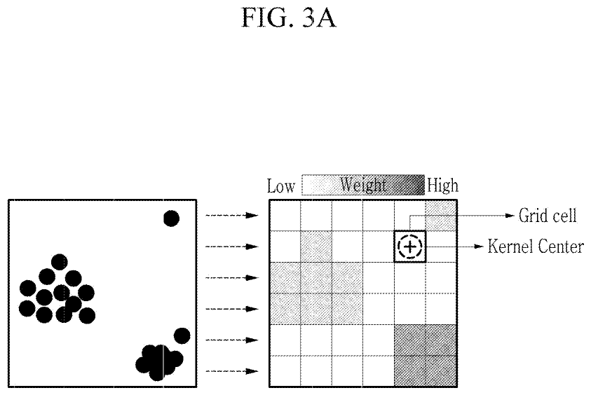

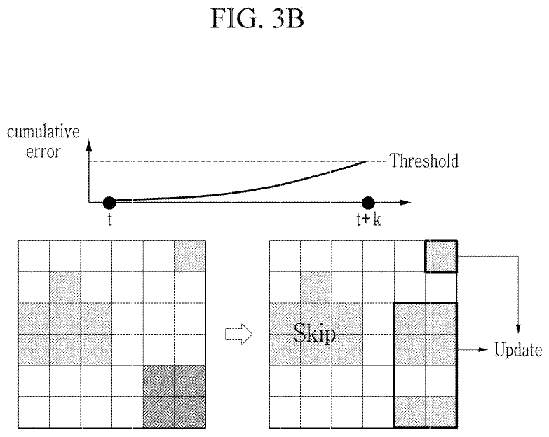

FIG. 3A and FIG. 3B are example diagrams illustrating a process of selecting an update region through data distribution approximation according to an embodiment.

FIG. 3A shows a data distribution approximation process of disposing a data distribution on a cell grid region, and FIG. 3B shows a cumulative net-change-based skip process of selecting a stationary region and an update region in the cell grid region.

As shown in FIG. 3A, multidimensional data are disposed in the grid cell regions of the same size. At this time, the grid cell may be implemented as a d-dimensional lattice cell having a diagonal length of θ_{R}. Then, the kernel center positioned at the center of each grid cell is fixed, and a density and weight are set for the kernel center.

Here, the density of the kernel center is determined according to a kernel function and distances between the kernel center and the k-nearest kernel centers, and the weight means the number of multidimensional data positioned within the corresponding grid cell.

And, as shown in FIG. 3B, a distribution of the multidimensional data input at a time point t is compared with a distribution of the multidimensional data updated at a time point t+k, and then a stationary region and an update region may be identified with a cumulative error(change) of the kernel center. The grid cell region whose cumulative error is smaller than a threshold is set to the stationary region. The stationary region and the update region differently set whether to update the density or not.

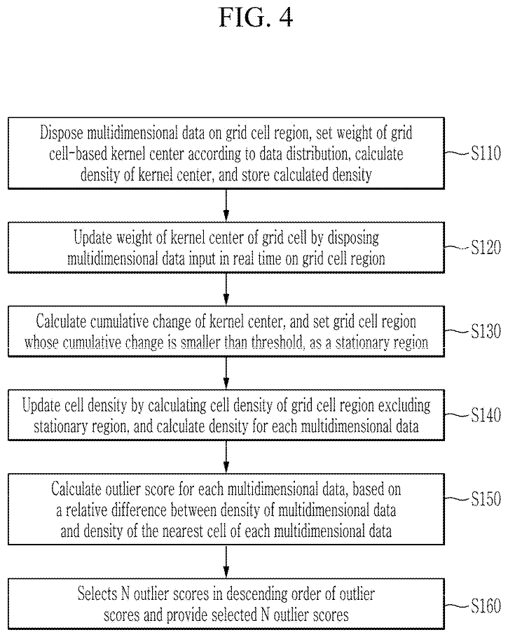

At this time, a criterion for classifying the stationary region and the update region is a predetermined threshold, and detailed description thereof will be followed with reference to FIG. 4.

FIG. 4 is a flowchart showing an outlier detection method according to an embodiment.

As shown in FIG. 4, an outlier detection device 100 disposes multidimensional data on a grid cell region, sets a weight of a grid cell-based kernel center according to a data distribution, calculates a density of the kernel center, and stores the calculated density (S110).

The outlier detection device 100 sets the number of multidimensional data positioned within the grid cell given a set of weighted kernel centers, and estimates the local density D (x) of a data point x using the following Equation 1.

$$D ( x ) = {\sum }_{i = 1}^{{θ}_{K}} \frac{{w}_{i}}{{\sum }_{i = 1}^{{θ}_{K}} {w}_{j}} {\prod }_{l = 1}^{d} {K}_{{h}^{1}} ( d i s t ( {x}^{1} , {kc}_{i}^{1} ) ) \qquad Equation 1$$

Here, kc₁, kc₂, . . . , kc_{θK} are the θₖ nearest kernel centers of data x, and h¹, x¹, and kc¹ are a bandwidth, the value of x, and the value of kc respectively, in 1-th dimension (1D) (1<1<d). In the 1-D, the bandwidth h¹ is set to the average of distances to the θ_{K} nearest kernel centers in the 1-th dimension. θₖ is a threshold on the number of neighbors. Kₕ is a kernel function with a bandwidth h.

Meanwhile, the outlier detection device 100 calculates the density of multidimensional data.

Next, the outlier detection device 100 updates the weight of the kernel center of the grid cell, by disposing the multidimensional data input in real time on the grid cell region (S120).

Then, the outlier detection device 100 calculates a cumulative change of the kernel center, and sets a grid cell region whose cumulative change is smaller than a threshold, as a stationary region (S130).

The outlier detection device 100 calculates the cumulative change of the kernel center by using the following Equation 2. Here, the cumulative change of the kernel center substantially means a net change of the multidimensional data. When multidimensional data a, b, and c are positioned in a specific kernel center at an immediately previous time point and multidimensional data b, c, and d are positioned in the specific kernel center at a current time point, the weight of the kernel center does not change. This is because the number of the multimedia data positioned within the specific kernel center remains the same though the data a moves out and the data d moves in.

Namely, the outlier detection device 100 may calculate the net change using only the number of the multidimensional data positioned within a corresponding grid cell not the movement of the specific multidimensional data.

$$E ( x ; {t}_{c} , {t}_{l} ) = {\sum }_{t = {t}_{l} , … , {t}_{c}} \frac{{\sum }_{Δ {w}_{j} ∈ {Δ𝒲}_{t} ( x : {t}_{l} )} \vert Δ {w}_{j} \vert}{{\sum }_{{w}_{i} ∈ 𝒦𝒞 ( x : {t}_{l} )} {w}_{i}} \qquad Equation 2$$

Here, E(x;t_{c},tₗ) is cumulative change E of data x between a time point t_{c} and a time point tₗ, k_{C} is a set of the θ_{K} nearest kernel centers at the time point tₗ, ΔWₜ is a set of weight change of nearby kernel centers, and w is a weight of a kernel center.

Meanwhile, the outlier detection device 100 may adjust a threshold in consideration of speed improvement and accuracy through a sensitivity experiment at a previous time point.

Here, the threshold ranges from 0 to 1. As the threshold approaches 0, a density error is not allowed, and only a region without density change is set as a stationary region for which density update is to be skipped. Further, as the threshold grows apart from 0, the density error is allowed to some degree. When a density change is less than or equal to the threshold though there exists the density change, the corresponding region is set as the stationary region.

Meanwhile, the outlier detection device 100 may define an upper bound of a cumulative change as shown in the following Equation 3.

$$\vert Δ ( x ) \vert = \vert {curr}_{} ( x ) - {last}_{} ( x ) \vert \leq \vert \frac{γ ( {{𝒦}_{\tilde{h}} ( 0 )}^{d} - {𝒟}_{last} ( x ) )}{1 + γ} \vert \qquad Equation 3$$

Here, D_{curr}(x) is a density calculated at a current time, Dₗₐₛₜ(x) is a density at a time point of the last update, Kₕ(0) is a kernel function, and γ is a predetermined threshold.

In this way, the outlier detection device 100 can check the degree of density error, based on the threshold predetermined through the upper bound of the derived cumulative change.

In other words, when the density update is skipped by setting the stationary region based on the threshold, the corresponding density error can be checked and whether the density error falls within an allowable range can be checked.

In addition, when an administrator would like to set the cumulative change used for estimating the stationary region as a specific value, the threshold may be determined through reverse calculation of Equation 3.

Next, the outlier detection device 100 updates a cell density by calculating the cell density of the grid cell region excluding the stationary region and calculates the density for each multidimensional data (S140).

The outlier detection device 100 may calculate the density of each kernel center positioned in the update region with the above-described Equation 1, and may calculate the density of each multidimensional data at the current time.

Meanwhile, the outlier detection device 100 may skip the density update for the stationary region and maintain the density of the corresponding grid cell at the time point of last update as it is.

The outlier detection device 100 may store the density of each kernel center of the grid cell region on a separate database for each time point. When the density values of some kernel centers in the grid cell region are updated, only the updated portion can be changed and then stored.

In this case, the outlier detection device 100 may store the density of each kernel center at each time point, and each density value may be stored along with the update time point.

Next, the outlier detection device 100 calculates an outlier score for each multidimensional data, based on a relative difference value between the density of the multidimensional data and a density of the nearest cell of each multidimensional data (S150). The outlier score S(x) is calculated as

$$S ( x ) = \frac{D ( x ) - {μ}_{k}}{{σ}_{k}} ,$$

μ and σ are the mean and standard deviation of the local densities at the O_{K} nearest kernel centers of x.

The outlier detection device 100 may calculate a relative difference value between the density of the multidimensional data and the density of the nearest kernel center of each multidimensional data, as an outlier score of a density of the corresponding multidimensional data.

Namely, the outlier detection device 100 may calculate an outlier score corresponding to each outlier degree and exhibit the outlier with a quantitative value.

Distance values with the k nearest kernel centers vary according to the position of the multidimensional data based on the size θ_{R} of a grid cell, which is used for calculating an upper bound and a lower bound of the density by the outlier detection device 100.

For example, since the distance value of a multidimensional data positioned in a grid cell is changed by the multidimensional data positioned near to the kernel center of the corresponding grid cell and the multidimensional data positioned on the edge of the corresponding grid cell, the upper bound and the lower bound of the density of the multidimensional data can be calculated.

In detail, the outlier detection device 100 can calculate an upper bound Dᵤₚ(c) and a lower bound D_{low}(c) on the density of the multidimensional data in a grid cell unit by using Equation 4, and an upper bound Sᵤₚ(c) and a lower bound S_{low}(c) of an outlier according thereto can be calculated.

$${low}_{} ( c ) = {\sum }_{i = 1}^{{θ}_{K}} \frac{{w}_{i}}{{\sum }_{j = 1}^{{θ}_{K}} {w}_{j}} {\prod }_{l = 1}^{d} {𝒦}_{{h}^{l}} ( dist ( {kc}^{l} , {kc}_{i}^{l} ) + \frac{{θ}_{R}}{2 \sqrt{d}} ) \\ {up}_{} ( c ) = {\sum }_{i = 1}^{{θ}_{K}} \frac{{w}_{i}}{{\sum }_{j = 1}^{{θ}_{K}} {w}_{j}} {\prod }_{l = 1}^{d} {𝒦}_{{h}^{l}} ( dist ( {kc}^{l} , {kc}_{i}^{l} ) - \frac{{θ}_{R}}{2 \sqrt{d}} ) \\ {𝒮}_{low} ( c ) = \frac{μ - {up}_{} ( c )}{σ} \leq 𝒮 ( x ) \leq {𝒮}_{up} ( c ) = \frac{μ - {low}_{} ( c )}{σ} \qquad Equation 4$$

Here, c indicates a grid cell and kc indicates a kernel center, and μ and σ are an average and a standard deviation of local densities at the θ_{K} nearest kernel centers of kc, respectively.

And the local density D(x) of x ∈ X^{d}(kc) is bounded as D_{low}(c)≤D(x)≤Dᵤₚ(c). X^{d} is a set of d-dimensional data points, X^{d}(kc) is a set of data points represented by kc.

Next, the outlier detection device 100 selects N outlier scores in the descending order of the outlier scores and provides the selected N outlier scores (S160).

The outlier detection device 100 may arrange the outlier scores in descending order and selects N outlier scores sequentially from the largest outlier score. As a result, the outlier detection device 100 can provide multidimensional data having the selected outlier scores. N is a natural number.

Here, the outlier detection device 100 may compare the upper bound and the lower bound of the outlier score in a grid cell unit to select at least one candidate grid cell including multidimensional data derived as the outlier, among the grid cells.

Further, the outlier detection device 100 can detect, as outliers, the N multidimensional data having the highest outlier scores by comparing only the outliers of the multidimensional data positioned in the candidate grid cell, without comparing the outliers of all the multidimensional data.

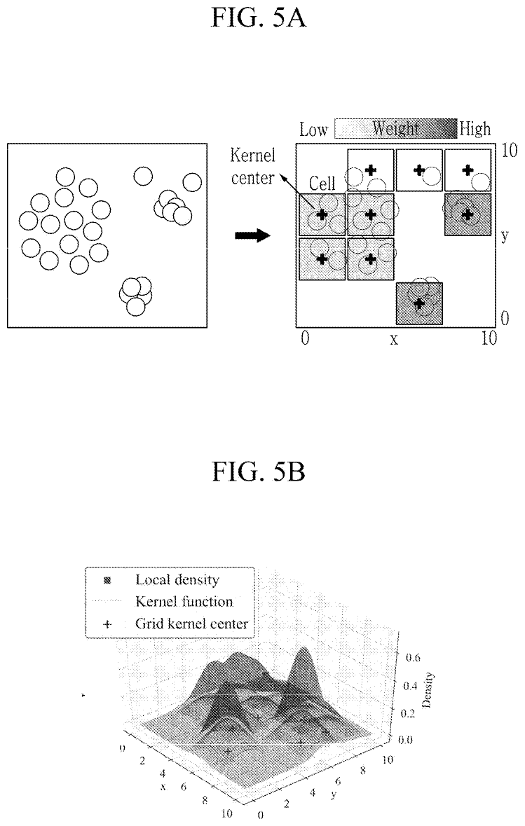

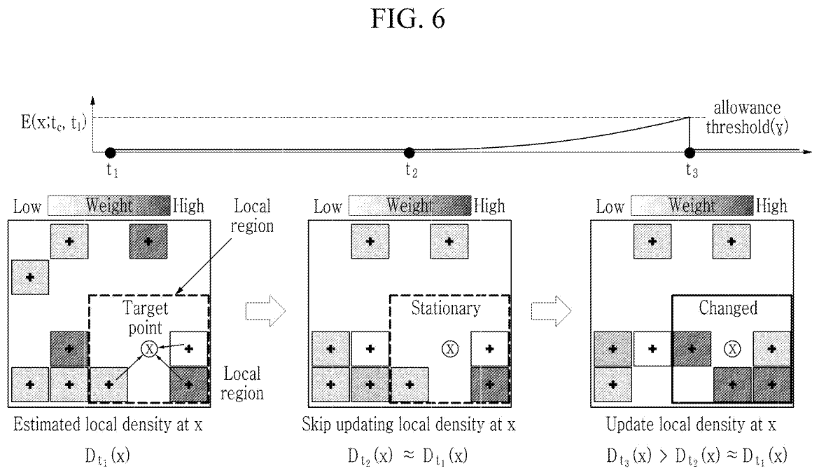

Hereinafter, a process of setting a stationary region through data distribution approximation and of detecting an outlier will be described in detail with reference to FIG. 5 to FIG. 7.

FIG. 5A and FIG. 5B are example diagrams illustrating a process of local density estimation by a data distribution approximation according to an embodiment.

FIG. 5A shows a multidimensional data disposes on a grid cell region, and FIG. 5B is a graph of regional density estimation.

Referring to FIG. 5A, the outlier detection device 100 may dispose raw data distribution on the grid cell region with kernel center. The outlier detection device 100 may determines the number of data points in each grid cell. The number of data points in each grid cell becomes a weight of the kernel center being a center of the grid cell.

At this time, if a data is overlapped in several grid cells, the outlier detection device 100 may put the data in one grid cell including the largest portion of the data. In other words, one multidimensional data is set to be included in one grid cell.

As described above, since the weight of the kernel center means the number of multidimensional data in the grid cell, updating the weight is easy and a change can be easily calculated by comparison with the time point of last update.

A calculation result of the density of the kernel center and that of each multidimensional data is as shown in FIG. 5B. The outlier detection device 100 may set a weight of a grid cell-based kernel center according to a data distribution, and estimate the local density D(x) using the Equation 1.

As described above, a method for calculating the density of the kernel center and a method for calculating the density of the multidimensional data are the same. The outlier detection device 100 determines each density according to a kernel function and distances with the k nearest kernel centers.

FIG. 6 is an example diagram illustrating a stationary region and an update region according to an embodiment.

FIG. 6 shows a process of setting a stationary region on the basis of a cumulative change, based on a weight change of the nearest kernel center of the multidimensional data within a box positioned in the right lower part of the recently updated data distribution.

FIG. 6 shows a data distribution at a time point ti, a data distribution at a time point t₂, and a data distribution at a time point t₃.

A density of a target point x (x is a specific multidimensional data) Dₜ₁(x) is calculated based on a distance with k kernel centers nearest to the target point x and a kernel function.

From a data distribution updated later at the time point t₂, it can be seen that the density of a target point x Dₜ₁(x) is almost the same as a density of the target point x Dₜ₂(x) that is calculated based on the kernel function and distances with the k kernel centers near to the target point x.

In other words, since the density value of the target point varies according to changes in the weights of k kernel centers nearest to the corresponding target point, being no change in the weights of the k nearest kernel centers makes it possible to assume that the density value of the target point does not change.

At this time, the outlier detection device 100 sets a region of the corresponding target point x as a stationary region and maintains the density of the kernel center within the region of the target point x set at the time point t₁.

On the other hand, from a data distribution updated at the time point t₃, it can be seen that a calculated density Dₜ₃(x) of the target point x is changed due to the change in the weights of the k kernel centers nearest to the target point x.

Accordingly, the outlier detection device 100 calculates a cumulative change (a cumulative change E of data x between the time point t₂ and the time point t₃) for the target point x at time t₃ (E(x: t₂, t₃)), and checks whether the calculated cumulative change is less than or equal to a predetermined allowance threshold.

Here, when the cumulative change of the weight is less than or equal to the allowance threshold, it can be assumed that the accuracy of the outlier detection does not deteriorate. When the cumulative change is greater than or equal to the allowance threshold, the corresponding region may be classified as an update region.

Since the cumulative change for the target point x at the time point t₃ is greater than the predetermined allowance threshold, the outlier detection device 100 calculates the density of the kernel center within the region of the corresponding target point x and updates the calculated density.

Through this process, the outlier detection device 100 may maintain the density of the kernel center at a previous time point by setting the stationary region or may calculate the density of the kernel center at the current time point to update the calculated density.

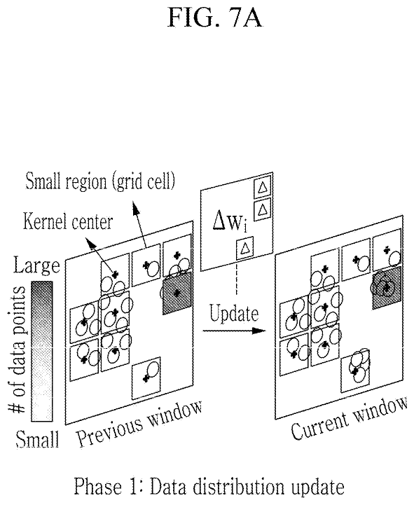

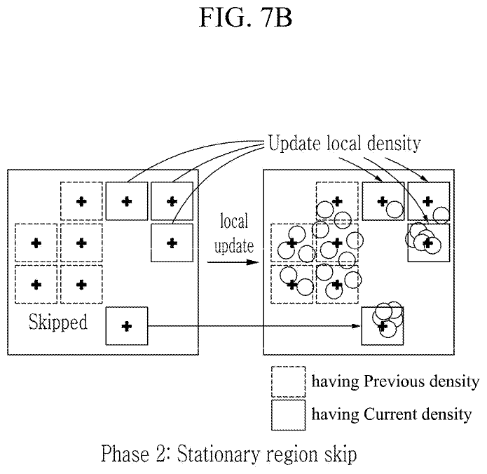

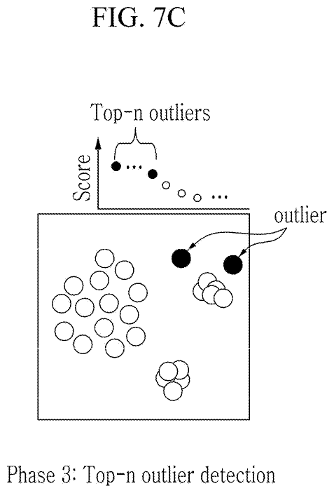

FIG. 7A, FIG. 7B and FIG. 7C are example diagrams illustrating a process of detecting an outlier in a real-time multidimensional data stream according to an embodiment.

FIG. 7A shows a phase 1 for data distribution update, FIG. 7B shows a phase 2 for stationary region skip, and FIG. 7C shows a phase 3 for top-n outlier detection. Referring to FIG. 7A, the outlier detection device 100 keeps track of the change by counting the number of data points in each small region and using the count as the weight of the kernel center derived from the region. A small region is implemented as a grid cell partitioning the data space. The resulting grid is called a weight distribution grid. The weights are updated efficiently by reflecting the net change of the count for each small region between the expired slide and the new slide to the weight distribution grid of the previous window.

Referring to FIG. 7B, the outlier detection device 100 examines the changes of weights in the weight distribution grid between consecutive sliding windows and identifies stationary regions, where the cumulative changes of the nearby kernel centers are not significant. Then, the outlier detection device 100 skips updating the local densities at data points in those stationary regions and instead reuses the local densities estimated in previous windows. Therefore, the stationary region maintains a previous density, and the update region newly calculates a current density.

Referring to FIG. 7C, the outlier detection device 100 chooses the top-n local outliers based on the local outlier scores of data points, while efficiently pruning small regions and data points that have low scores. The outlier detection device 100 finally determines an outlier score based on a relative difference between a density value of multidimensional data and a density value of the nearest kernel center of the multidimensional data.

For example, an algorithm describing an outlier detection process by the outlier detection device 100 is as shown in Table 1.

TABLE 1
Algorithm 1 Overall Procedure of STARE

| INPUT: a data stream DS, the number n of outliers to find | |
|---|---|
| OUTPUT: a set O of top-n outliers for each window | |
| 1: | for each window [symbol] sliding on DS do |
| 2: | Sₑₓₚ ← the expired slide; S_{new} ← the new slide; |
| 3: | [symbol] ^{prev} ← the previous weight distribution grid; |
| 4: | /* 1. DATA DISTRIBUTION UPDATE */ |
| 5: | ( [symbol] ^{curr}, Δ [symbol] ) ← UpdateDistribution( [symbol] ^{prev}, Sₑₓₚ, S_{new}); |
| 6: | /* 2. STATIONARY REGION SKIP */ |
| 7: | [symbol] ← UpdateChangedRegion( [symbol] , [symbol] ^{curr}, Δ [symbol] ); |
| 8: | /* 3. TOP-n OUTLIERS DETECTION */ |
| 9: | O ← DetectLocalOutliers( [symbol] , n); |
| 10: | return O; |
| 11: | end for |

However, implementing the stationary region skipping poses significant challenges. First, tracking where and how the densities at data points change significantly should be done without actually calculating their densities in the data space, as it is an expensive operation. Second, skipping stationary regions should not damage the outlier detection accuracy as a result. The outlier detection device 100 addresses the challenges. The outlier detection device 100 is the first that fully exploits the density stationarity of a data stream towards achieving fast and accurate density updates. Specifically, the outlier detection device 100 uses kernel density estimation (KDE) to compute densities at data points while employing the following two techniques for stationary region skipping.

Data distribution approximation (KDE) requires a set of kernel centers used to determine the local densities at their neighboring data points by a certain kernel function. By virtue of KDE, the outlier detection device 100 can track only the change of the distribution of kernel centers, which is an indicator of the data density changes. Notably, kernel centers are derived from a set of fixed small regions partitioning the data space. Their fixed possible positions make it very efficient to maintain and update them.

Cumulative net-change-based skip is built upon a systematic skipping framework based on a quantification of the changes of kernel center distribution across sliding windows. The outlier detection device 100 updates the density only in the regions where the cumulative net-change of kernel center distribution becomes significant. The bounds on the density error resulting from skipping density updates is theoretically analyzed to provide both exact and approximate skipping strategies accordingly.

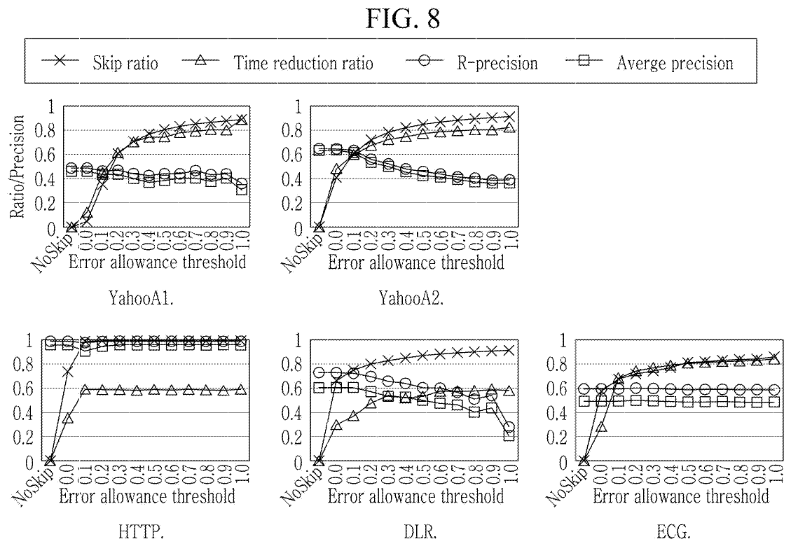

FIG. 8 is a result graph of a sensitivity experiment of varying an error allowance threshold of a cumulative change according to an embodiment.

FIG. 8 is a result graph obtained from measuring R-precision, average precision, skip ratio, and time reduction ratio with increasing a threshold γ from 0 to 1 for 5 data sets.

Here, the skip ratio indicates a ratio between the number of skipped grid cells and the number of non-skipped grid cells and the time reduction ratio indicates a ratio of stored CPU time to the entire CPU time. In addition, the R-precision is a value obtained through dividing the number of true outliers by the number of true outliers among the n detected outliers, and the average precision is a value obtained through dividing the number of true outliers by the sum of the precisions of high-ranked detected outliers.

Here, 4 real data sets (YahooA1, HTTP, DLR and ECG) and 1 synthetic data set (YahooA2) are used as the 5 data sets. YahooA1 includes a data set collected from Yahoo! Service with human-labeled outliers, and YahooA2 includes a synthetic data set generated with a varying trend, noise and seasonality, and HTTP includes outliers for various network attacks. Further, DLR is collected for activity recognition system and includes measurement values of sensors attached to a human body. In addition, ECG includes a function extracted from electrocardiogram signals and abnormal heartbeat signals are labeled as outliers. In general, since the speed improvement and the accuracy of outlier detection are in a trade-off relationship, it is important to set a point capable of improving the speed to the maximum while securing the detection accuracy.

As shown in FIG. 8, it can be seen that both the skip ratio and the time reduction ratio increase with the increase in the allowance threshold for all data sets and the accuracy deteriorates as the more grid cells are skipped.

Further, it can be seen that the speed improvement by 1.6 to 3.2 times is obtained for all the data sets while securing high accuracy when the threshold γ becomes 0.1 in each graph.

In other words, the outlier detection device 100 can set a threshold of 0.1 capable of securing the speed improvement and the high accuracy through a sensitivity experiment on the threshold for each data set to be applied.

On the other hand, it can be seen that HTTP and ECG do not suffer from accuracy loss despite the high skip ratio. Since the density distribution of the data set rarely changes over time, the accuracy loss does not occur. In case of HTTP and ECG, local outliers can be effectively detected even in an outdated data distribution.

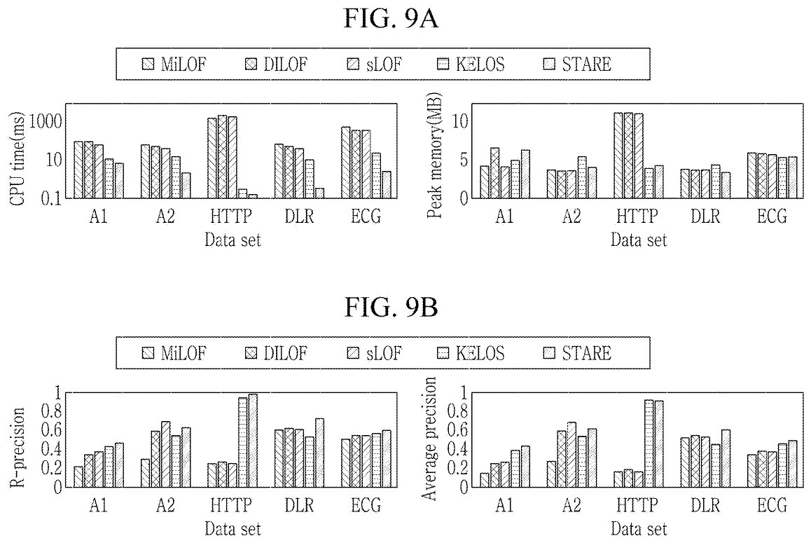

FIG. 9A and FIG. 9B are result graphs showing performance evaluation of the present disclosure.

In FIG. 9A is a graph showing CPU time and maximum memory usage based on 5 algorithms including the present disclosure, and FIG. 9B is a graph showing the accuracy for each algorithm.

FIG. 9A and FIG. 9B are result graphs showing performance evaluation using each of reference values predetermined based on the data types as shown in the following Table 2.

TABLE 2

| Data set | Dim. | Size | Window size | Slide size | Outlier ratio |
|---|---|---|---|---|---|
| YahooA1 | 1 | 95K | 1,415 | 71 | 1.7% |
| YahooA2 | 1 | 142K | 1,421 | 71 | 0.3% |
| HTTP | 3 | 567K | 6,000 | 300 | 0.3% |
| DLR | 9 | 23K | 1,000 | 50 | 2.2% |
| ECG | 32 | 112K | 2,237 | 117 | 16.3% |
| FDC | 32 | 1.6K | 534 | 24 | 0.2% |

Here, the FDC includes sensor readings collected from facilities in a semiconductor factory.

The CPU time, the maximum memory usage, and the accuracy precision (R-R-precision and average precision), predetermined as performance evaluation criteria, are compared for these data set by using a detection method (STARE) provided in the present disclosure and existing four algorithms (sLOF (vanilla LOF), MiLOF (compression-based LOF), DILOF (sampling-based LOF), and KELOS (micro-cluster kernel center)).

Referring to FIG. 9A and FIG. 9B, it can be seen that a real-time outlier detection method (STARE) according to an embodiment has the fastest detection speed compared to other algorithms when averaged over all data sets.

In detail, it can be seen that the real-time outlier detection method (STARE) has a speed 3,107 times faster than the sLOF algorithm and 11 times faster than KELOS. In addition, despite this speed improvement, it can be seen that STARE consumes comparable memory space while achieving the highest outlier detection accuracy.

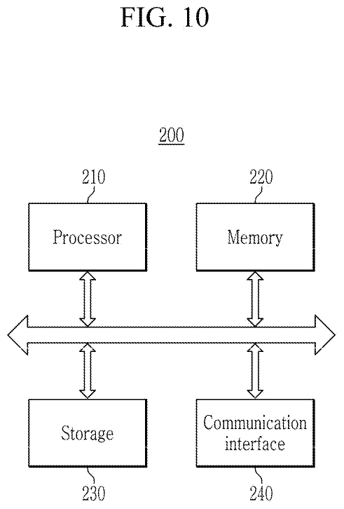

FIG. 10 is a hardware configuration diagram of a computing device according to an embodiment.

As shown in FIG. 10, a data distribution updater 110, a stationary region setter 120, a density calculator 130, and an outlier detector 140 may be implemented as a computing device 200 operated by at least one processor.

Hardware of the computing device 200 may include at least one processor 210, a memory 220, a storage 230, and a communication interface 240, and a bus may connect them. In addition, various elements such as an input device and an output device may be further included.

The processor 210 is a device that controls the operation of the computing device 200, and may be various types of processors that process instructions included in a computer program. For example, the processor 210 may be a central processing unit (CPU), a micro processor unit (MPU), a micro controller unit (MCU), a graphic processing unit (GPU). Alternatively, the processor 210 may be implemented with including at least one of any type of processor well known in the art.

The memory 220 loads the computer program so that the instructions described to perform the operation of the present disclosure are processed by the processor 210. The memory 220 may be, for example, a read only memory (ROM), a random access memory (RAM), and the like.

The storage 230 stores various types of data, computer programs, and the like required to perform the operation of the present disclosure. The communication interface 440 may be a wired/wireless communication module.

The computer program includes instructions executed by the processor 210 and is stored in a non-transitory computer readable storage medium. The instructions make the processor 210 to perform the operations of the present disclosure. The computer program may be downloaded via network or sold in product form.

According to an embodiment of the present disclosure, unnecessary density update is prevented by skipping update for the stationary region. Thus, the calculation amount can be minimized, thereby improving the speed of outlier detection.

In addition, the improvement of detection speed is secured without degrading the outlier detection accuracy, by setting the stationary region through comparison of a predetermined threshold and a cumulative change calculated based on a weight change of the nearest kernel center of each multidimensional data.

While this invention has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

1. A method of detecting an outlier in real time in a multidimensional data stream, implemented by a computing device including at least one processor, the method comprising:
disposing multidimensional data input in real time on a grid cell region and setting a weight for a kernel center of each grid cell based on a data distribution on the grid cell region;
calculating a cumulative change of a weight for each corresponding kernel center by comparing a data distribution at a current time and a data distribution at a previous time, and setting a stationary region in the grid cell region based on the cumulative change;
maintaining a density of a kernel center of the stationary region as a previous density, and calculating a density of a kernel center excluding the stationary region to update the calculated density; and
estimating a density of multidimensional data at the current time, and detecting an arbitrary number of outliers based on a relative difference between the density of the multidimensional data and a density of a kernel center nearest to the multidimensional data.

2. The method of claim 1, wherein setting the weight for the kernel center comprises setting number of multidimensional data positioned in the grid cell as the weight of the kernel center for the grid cell.

3. The method of claim 1, wherein setting the stationary region comprises classifying a grid cell whose cumulative change, representing a net change in the number of data, is less than or equal to a predetermined threshold as the stationary region and classifying a grid cell whose cumulative change is greater than the threshold as an update region.

4. The method of claim 3, wherein calculating the density of the kernel center excluding the stationary region comprises calculating the density of the corresponding kernel center based on a kernel function and distances with the k (k is a natural number) nearest different kernel centers in the update region.

5. The method of claim 3, wherein detecting the arbitrary number of outliers comprises estimating a density of each multidimensional data based on a kernel function and distances among the k (k is a natural number) nearest kernel centers at a position of each multidimensional data at the current time.

6. The method of claim 5, wherein detecting the arbitrary number of outliers comprises estimating the relative difference as an outlier score, and detecting the arbitrary number of multidimensional data in the sequential order of the highest outlier score as the outliers or detecting multidimensional data whose outlier score is greater than or equal to a predetermined allowance threshold as the outliers.

7. The method of claim 6, wherein detecting the arbitrary number of outliers comprises estimating an upper bound and a lower bound of a density of the multidimensional data for each grid cell based on the position of the multidimensional data in the grid cell, and calculating an upper bound and a lower bound of an outlier score based on the upper bound and the lower bound of the density of the multidimensional data.

8. The method of claim 6, wherein detecting the arbitrary number of outliers comprises comparing an upper bound and a lower bound of an outlier score for each grid cell to select, as a candidate grid cell, at least one grid cell having a lower bound of the outlier score higher than an upper bound of the outlier score of some grid cells, and detecting the arbitrary number of the multidimensional data as the outliers from the multidimensional data positioned in the candidate grid cell.

9. A computing device comprising:
a memory including instructions; and
at least one processor that executes the instructions to detect an outlier in a multidimensional data stream,
wherein the at least one processor
disposes multidimensional data input in real time on a grid cell region and sets a weight for a kernel center of each grid cell based on a data distribution on the grid cell region,
classifies a stationary region and an update region according to a cumulative change of a weight predetermined for a kernel center of the corresponding grid cell, by comparing a data distribution at a current time and a data distribution at a previous time, and
calculates a density of a kernel center in the update region to update the calculated density, estimates a density for each of the multidimensional data, and detects an arbitrary number of outliers based on a relative difference between a density of the multidimensional data and a density of the kernel center nearest to the corresponding multidimensional data.

10. The computing device of claim 9, wherein the at least one processor sets the number of the multidimensional data positioned in the grid cell as the weight of the kernel center, and calculates a cumulative change from a change in a weight distribution of the kernel center.

11. The computing device of claim 9, wherein the at least one processor calculates a density of the kernel center or a density of the multidimensional data based on a kernel function and distances with the k nearest kernel centers at each position.

12. The computing device of claim 9, wherein the at least one processor maintains a density of the kernel center of the stationary region as a previous density, calculates the density of the kernel center of the update region excluding the stationary region, updates the calculated density of the kernel center, and stores the density of the kernel center at the current time.

13. The computing device of claim 9, wherein the at least one processor
estimates an upper bound and a lower bound of the density of the multidimensional data for each grid cell based on a position of the multidimensional data in the grid cell, calculates an upper bound and a lower bound of the relative difference based on the upper bound and the lower bound of the density, and
selects, as a candidate grid cell, a grid cell that has the lower bound of the relative difference greater than the upper bounds of other grid cells through comparing the upper bounds and the lower bounds of the grid cells.

14. The computing device of claim 13, wherein the at least one processor
selects at least one candidate grid cell so that the number of multidimensional data positioned in the candidate grid cell is greater than the arbitrary number, and
selects the arbitrary number of the multidimensional data in the sequentially higher order of the relative difference as outliers among the multidimensional data positioned in the candidate grid cell.
